(19) United States
(12) Patent Application Publication
(10) Pub. No.: US 2009/0265094 A1
(43) Pub. Date: Oct. 22, 2009

(54) METHOD AND SYSTEM FOR INFORMATION CORRESPONDING TO GEOGRAPHICAL POSITION

(75) Inventors: Yi-Hsiu Lee, Taipei (TW); Hung-Hsiang Chen, Taipei (TW); Yang-Po Chiu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/398,157

(22) Filed: Mar. 4, 2009

(30) Foreign Application Priority Data
Apr. 18, 2008 (TW) 97114253

(51) Int. Cl. G01C 21/00; G06F 17/30

(52) U.S. Cl. 701/200; 707/3; 707/104.1; 707/E17.018; 707/E17.108

(57) ABSTRACT

The invention relates to a method and a system for information corresponding to a geographical position. The method includes the following steps. First, a plurality of words are captured from electronic information. Then, position information conforming to a specific address format is searched out in the captured words. Furthermore, the position information is converted to latitude and longitude data.

### CROSS-REFERENCE TO RELATED APPLICATION

This application claims the priority benefit of Taiwan application serial no. 97114253, filed on Apr. 18, 2008. The entirety of the above-mentioned patent application is hereby incorporated by reference herein and made a part of specification.

### BACKGROUND OF THE INVENTION

1. Field of the Invention

The invention relates to an information integrated technique and, more particularly, to a technique for information corresponding to a geographical position.

2. Description of the Related Art

Generally, before people visit a strange place, they may look up destination information (such as tourist attractions or dining-room information and so on) via the Internet. Since the data of web pages lack arrangements, they are inconvenient to carry outdoors. Thus, people need to arrange the needed information (such as destination addresses or telephones and so on), and they have to write down or print the needed information and carry the information which is written or printed when they are away from home. For a user having a navigation device, after he or she looks up the needed information, the user needs to input a plurality of found information into the navigation device one after another to record the destination information.

In addition, in the prior art, after the user looks up the needed destination information and edits the information via software on a computer, he or she may connect the navigation device to the computer to transfer the edited information to the navigation device. However, no matter using the mode of printing or writing down the information by the users or the mode of editing the information via the software, the operating steps of the both are complicated, which causes inconvenience.

### BRIEF SUMMARY OF THE INVENTION

The invention provides a method and a system for information corresponding to a geographical position, which are used to combine the information and the geographical position to increase operating convenience of users.

To solve the above problems, the invention provides a method for information corresponding to a geographical position. The method includes the following steps. First, a plurality of words are captured from electronic information. Then, position information conforming to a specific address format is searched out in the captured words. Furthermore, the position information is converted to latitude and longitude data.

In an embodiment of the invention, the step of capturing the words from the electronic information includes the following steps. A web page is browsed via a browser, and the web page has the electronic information. The words are captured from the web page. The step of searching for the position information conforming to the specific address format includes the following steps. First, a plurality of address formats are provided. Then, the specific address format is selected out from the address formats. Furthermore, the words conforming to the specific address format are searched for, and the words conforming to the specific address format are taken as the position information. The step of searching for the position information conforming to the specific address format includes the following steps. An address database is provided, and the address database stores corresponding relation between addresses and latitude and longitude. Then, the address database is used to find out the latitude and longitude data which the position information corresponds to.

In an embodiment of the invention, the method for the information corresponding to the geographical position further includes the following steps. The location of the position information is marked in a map. A specific position bookmark is built, and the specific position bookmark includes at least one of the position information and the latitude and longitude data.

In an embodiment of the invention, the method for the information corresponding to the geographical position further includes the following steps. The specific position bookmark is stored in a central server, and the specific position bookmark in the central server is stored in a navigation device.

The invention provides a system for information corresponding to a geographical position. The system includes a word capturing module, a searching module, and a geographical information converting module. The word capturing module is used to capture a plurality of words from electronic information. The searching module is used to search for position information conforming to a specific address format in the captured words. The geographical information converting module is used to convert the position information to latitude and longitude data.

In an embodiment of the invention, the system for the information corresponding to the geographical position further includes a browser for browsing a web page. The web page has the electronic information, and the word capturing module captures the words from the web page.

In an embodiment of the invention, the system for the information corresponding to the geographical position further includes an address database for storing corresponding relation between addresses and the latitude and longitude. The geographical information converting module utilizes the corresponding relation in the address database to find out the latitude and longitude data which the position information corresponds to.

In an embodiment of the invention, the system for the information corresponding to the geographical position further includes a bookmark building module for building a specific position bookmark. The specific position bookmark includes at least one of the position information and the latitude and longitude data.

In an embodiment of the invention, the system for the information corresponding to the geographical position further includes a central server and a navigation device. The central server is coupled with the bookmark building module, and it is used to store the specific position bookmark. The navigation device is coupled with the central server, and it is used to download the specific position bookmark in the central server. Furthermore, the navigation device may also be coupled with the bookmark building module, and it may be used to store the specific position bookmark.

In the invention, the position information of the electronic information is captured automatically. Therefore, a user does not need to input information manually, and he or she may handle affairs conveniently. At the same time, in the invention, the information and the geographical position may be combined. Thus, the position information found out from the electronic information may be used for navigating or planning travel and so on.

These and other features, aspects, and advantages of the present invention will become better understood with regard to the following description, appended claims, and accompanying drawings.

### BRIEF DESCRIPTION OF THE DRAWINGS

FIG. 1 is a flowchart showing steps of a method for information corresponding to a geographical position according to an embodiment of the invention;

FIG. 2 is a flowchart showing steps of a method for information corresponding to a geographical position according to an embodiment of the invention;

FIG. 3 is a schematic diagram of a web page browsed by a browser;

FIG. 4 is a flowchart showing substeps of step S220 according to an embodiment of the invention;

FIG. 5 is a schematic diagram showing a graphic interface of a plug-in according to an embodiment of the invention;

FIG. 6 is a schematic diagram showing a graphic interface of a plug-in according to an embodiment of the invention;

FIG. 7 is a schematic diagram showing a web page of a service website according to an embodiment of the invention;

FIG. 8 is a block diagram of a system for information corresponding to a geographical position according to an embodiment of the invention; and

FIG. 9 is a block diagram of a system for information corresponding to a geographical position according to an embodiment of the invention.

### DETAILED DESCRIPTION OF THE EMBODIMENTS

To solve the problem and avoid the complex actions such as arranging destination data before users are away from home and inputting the arranged data by themselves, the invention provides a method and a system for information corresponding to a geographical position to facilitate the integration of the destination data.

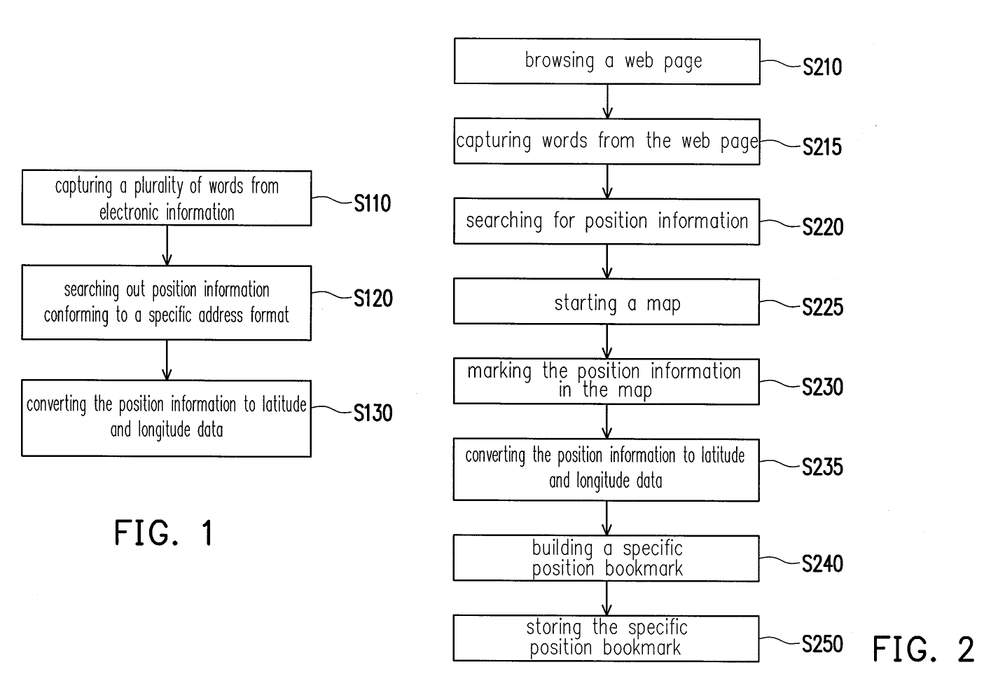

FIG. 1 is a flowchart showing steps of a method for information corresponding to a geographical position according to an embodiment of the invention. Assuming that the method for the information corresponding to the geographical position in the embodiment is used at an electronic device (such as a computer or a personal digital assistant), as shown in FIG. 1, first, the electronic device captures a plurality of words from electronic information (step S110). The electronic information may be data of a web page, and the step S110 is, for example, to capture words from the web page. That is, the electronic device may be connected to a network, and it may capture the words from the web page by browsing the web page via a browser. In addition, the electronic information may also be data of an E-mail or other data containing electronic travelling information.

Afterwards, the electronic device searches out position information conforming to a specific address format in the captured words (step S120). The position information includes address information or a coordinate and so on. The specific address format may be set according to a location area where the user is. Taking Taiwan area as an example, the specific address format may be ______city (county), ______road (street), ______section, ______lane, ______number. In other words, the electronic device searches the captured words and determines whether data conforming to the specific address format exist in the captured words to find out the position information conforming to the specific address format.

At last, the electronic device converts the position information to latitude and longitude data (step S130). In the embodiment, the converted latitude and longitude data may be stored in a central server or a computer via the network. When the user wants to be away from home, the user may plan his or her route via the latitude and longitude data as the latitude and longitude data stored in the central server or the computer are read to a navigation device. The converted latitude and longitude data may also be directly stored in the navigation device for the user to plan his or her route via the latitude and longitude data.

As stated in the embodiment, compared with the prior art, the user can avoid inputting a plurality of data into the navigation device one after another manually, and he or she can directly use the information of the web page or the E-mail and so on in the navigation device. To help people having ordinary skills in the art implement the invention via the embodiments, the invention provides another embodiment hereinbelow.

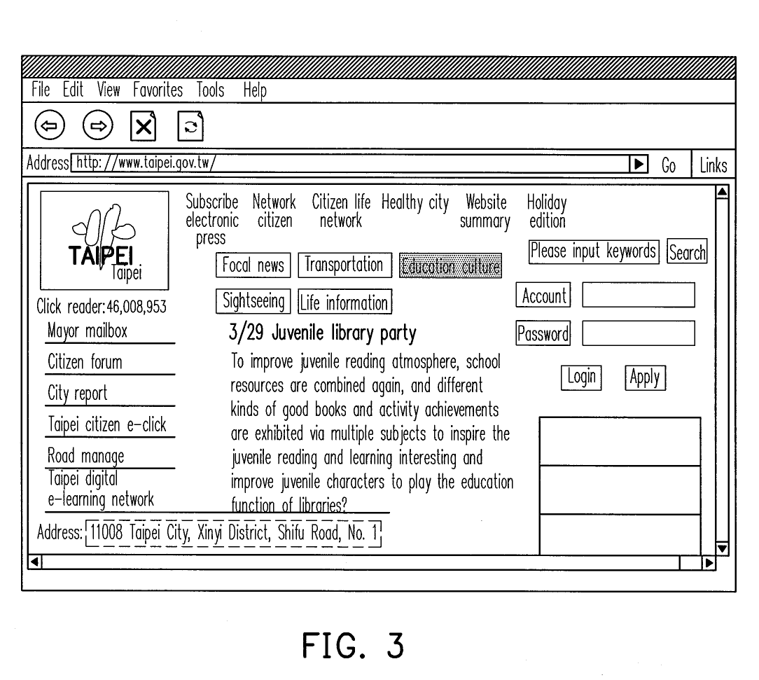

FIG. 2 is a flowchart showing steps of a method for information corresponding to a geographical position according to an embodiment of the invention. First, assuming that the method for the information corresponding to the geographical position is used at an electronic device, the electronic device has a browser. Furthermore, assuming that the method for the information corresponding to the geographical position in the embodiment is realized by a plug-in in the browser, as shown in FIG. 2, first, the electronic device may browse a web page via the internal browser (step S210). The web page includes travelling data such as dining-room introduction, tourist attractions introduction, or an official web page, and so on. For example, the browser browses the web page as shown in FIG. 3.

Afterwards, the plug-in captures the words from the web page (step S215), and it searches for position information in the captured words (step S220). In the embodiment, the position information may be an address or a coordinate and so on. To facilitate the description of the embodiment, the following position information is, for example, an address. However, since each country has different address formats, the plug-in of the embodiment may provide a plurality of address formats beforehand, and the user can select a specific address format according to the country of destination or the place where he or she is. Taking Taiwan area as an example, the specific address format may be ______city (county), ______road (street), ______section, ______lane, ______number. The step S220 is, for example, to search for the words conforming to the specific address format in the captured words and take the words conforming to the specific address format as the position information. As shown in FIG. 3, the plug-in may search out the position information “Taipei City, Xinyi District, Shifu Road, No. 1” in the words of the web page shown in FIG. 3.

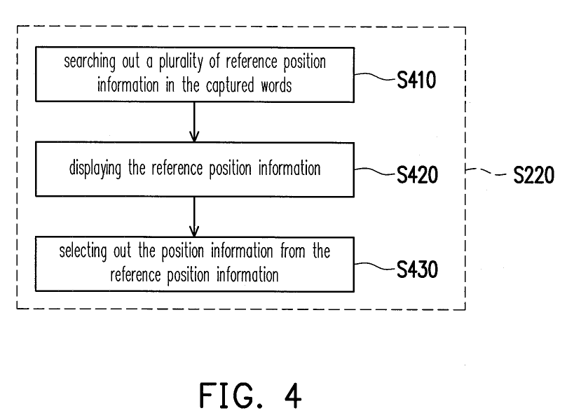

Furthermore, since the words of the browsed web page may include a plurality of data conforming to the specific address format, in another embodiment of the invention, the step S220 includes a plurality of substeps, as shown in FIG. 4. First, the plug-in searches out a plurality of reference position information conforming to the specific address format in the captured words (step S410). Then, the plug-in displays the searched reference position information (step S420). At last, the plug-in selects out the position information from the reference position information (step S430). The mode of selecting the position information may be that the plug-in determines whether the reference position information is effective information, respectively, or the plug-in provides an operating interface for the user to select out the position information from the reference position information.

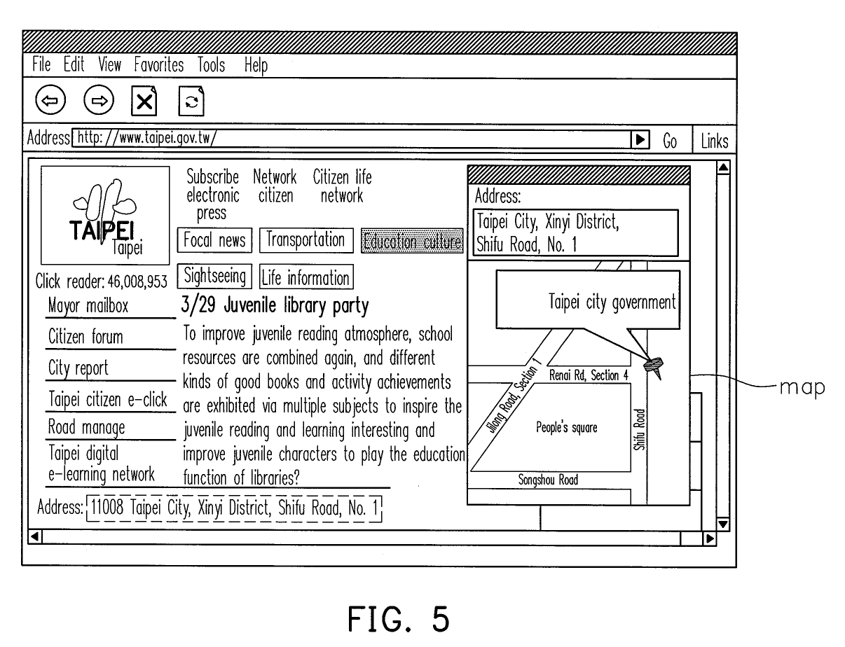

Afterwards, referring to FIG. 2, after the position information is searched out, the plug-in starts a map (step S225), and it marks the location of the position information in the map (step S230), as shown in FIG. 5. Then, the plug-in converts the position information to latitude and longitude data (step S235). As far as the present navigation software, the navigation software includes an address database, and the address database stores corresponding relation between addresses and latitude and longitude. By using the corresponding relation, the navigation software may use the position information to find out the latitude and longitude data which the position information corresponds to. Therefore, in the embodiment, the preceding navigation software technique may be used to find out the latitude and longitude data. The navigation software is, for example, Geotagging.

As stated in the step S230 and the step S235, the plug-in is, for example, to convert the position information to the latitude and longitude data after marking the position information. Furthermore, in the embodiment, after the position information is converted to the latitude and longitude data, the converted latitude and longitude data may also be used to mark the position information in the map.

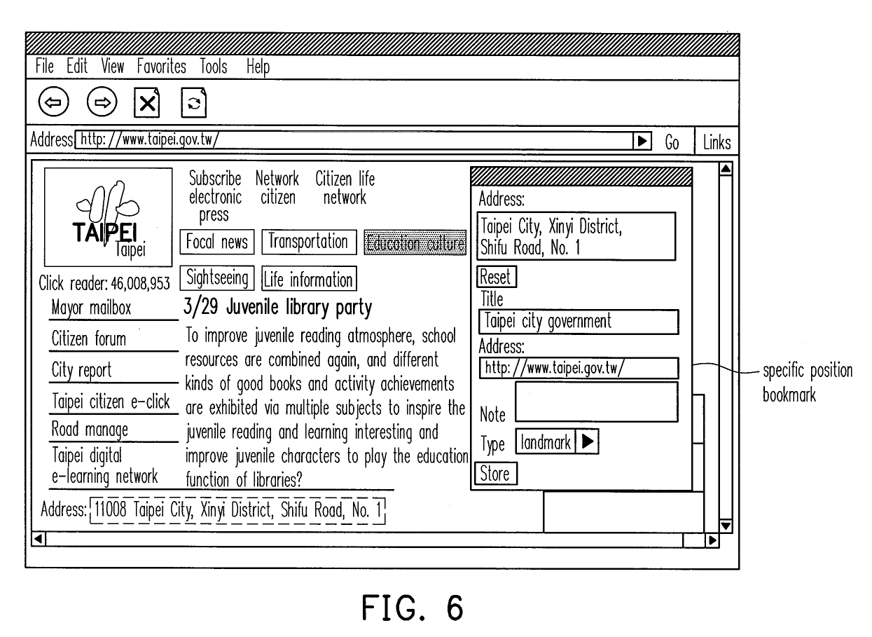

Afterwards, the plug-in builds a specific position bookmark (step S240), and the specific position bookmark includes at least the position information and the latitude and longitude data. In addition, in a preferred embodiment of the invention, the specific position bookmark may also include the website of the web page and the place name of the position information and so on. The user can edit his or her information which needs to be added in the specific position bookmark by himself or herself, as shown in FIG. 6. The place name to which the position information in the specific position bookmark corresponds may be looked up via a database. The user does not need to edit the place name by himself or herself. The website in the specific position bookmark may also be obtained by the plug-in automatically.

At last, the specific position bookmark is stored (step S250). In the embodiment, the specific position bookmark may be stored in the electronic device. The electronic device may also store the specific position bookmark in a central server via a network, or a navigation device is connected to the electronic device and the specific position bookmark may also be stored in the navigation device for the user to utilize the specific position bookmark for navigating when he or she is away from home. In the embodiment, if the electronic device, the central server or the navigation device has a map database originally, the specific position bookmark may mark the location of the specific position bookmark according to the internal latitude and longitude data.

In addition, if the specific position bookmark is stored in the central server, the navigation device of the user may be connected to the central server via the network, and the user may download the specific position bookmark in the central server when he or she is away from home or in home to navigate. Meanwhile, if a plurality of users use the method to build the position bookmarks in the central server, the central server may have a plurality of position bookmarks. The user can connect the navigation device to the central server and find the position bookmark related to the destination to plan travel before he or she goes to travel or is away from home. The position bookmarks downloaded to the navigation device by the user may be the bookmarks stored in the server by himself or herself beforehand, and they may also be the position bookmarks stored by other users.

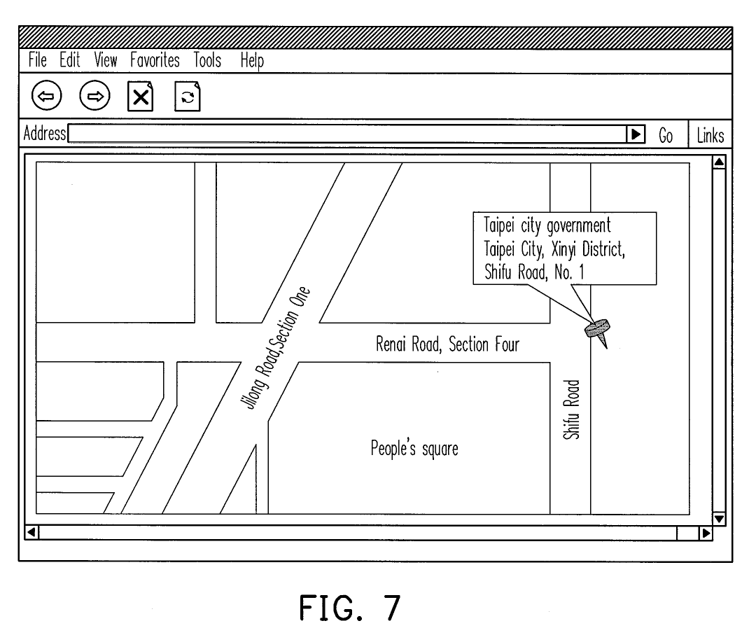

In the embodiment, the central server may build a service website for the user to look over the position bookmarks stored in the central server, as shown in FIG. 7. The user can connect to the service website to browse the position bookmarks of other users. In addition, the service website may also arrange the position bookmarks in the central server. When the user searches for the position bookmarks, they may know whether each place is set to be a position bookmark repeatedly and the number of times of setting a place to be the position bookmark, and then, they may know whether the place is an attractive place. Thus, the user can decide his or her travelling plan.

The electronic device and the navigation device may be a computer, a notebook computer, an ultra-mobile personal computer (UMPC) and a personal digital assistant, and so on. Furthermore, people having ordinary skills in the field may conclude that if the web page includes telephone information besides the position information in the above steps, in the embodiment, the telephone information may be searched for in the words of the web page and the telephone information may also be built in the specific position bookmark to complete the information in specific position bookmark.

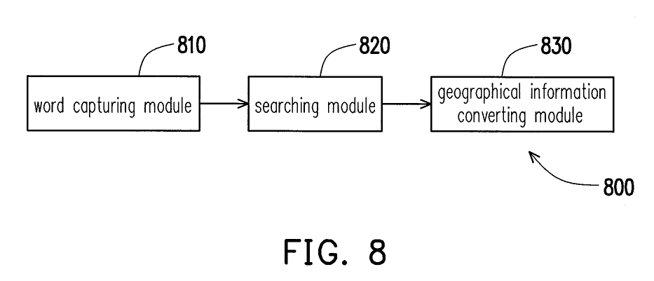

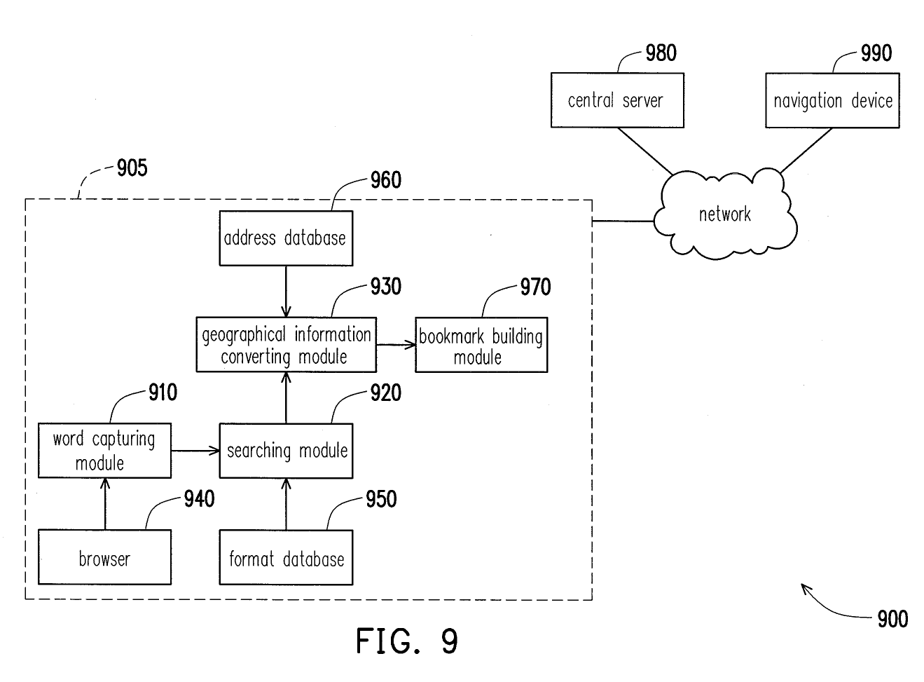

To help people having ordinary skills in the art implement the invention via the embodiments, the invention provides another embodiment hereinbelow. FIG. 8 is a block diagram of a system for information corresponding to a geographical position according to an embodiment of the invention. As shown in FIG. 8, a system for information corresponding to a geographical position 800 includes a word capturing module 810, a searching module 820, and a geographical information converting module 830. The word capturing module 810 captures a plurality of words from electronic information. The searching module 820 is coupled with the word capturing module 810, and it is used to search for position information conforming to the specific address format in the captured words. Since the operation of the searching module 820 is similar with the step S120 in FIG. 1, it is not described hereinbelow for a concise purpose. The geographical information converting module 830 is coupled with the searching module 820, and it is used to convert the searched position information to latitude and longitude data. Another embodiment of the invention is provided, as shown in FIG. 9.

As shown in FIG. 9, a system for information corresponding to a geographical position 900 includes a word capturing module 910, a searching module 920, a geographical information converting module 930, a browser 940, a format database 950, an address database 960, and a bookmark building module 970. The browser 940 browses a web page, and the web page has electronic information. The word capturing module 910 is coupled with the browser 940, and it captures a plurality of words from the web page browsed by the browser 940.

The format database 950 stores a plurality of address formats. The searching module 920 is coupled with the word capturing module 810 and the format database 950, and it uses address formats stored in the format database 950 to search out the position information conforming to the specific address format of the address formats. The address database 960 stores corresponding relation between addresses and latitude and longitude, and the geographical information converting module 930 utilizes the corresponding relation in the address database 960 to search out the latitude and longitude data which the position information corresponds to. The bookmark building module 970 builds a specific position bookmark, and the specific position bookmark includes at least one of the position information and the latitude and longitude data.

The system for the information corresponding to the geographical position 900 may be used at an electronic device 905, and the electronic device 905 may be connected to a central server 980 via a network interface. The central server 980 stores the specific position bookmark built by the bookmark building module 970. In addition, the system for the information corresponding to the geographical position 900 further includes a navigation device 990, and the navigation device may also be connected to the central server 980 via the network interface and download the stored specific position bookmark beforehand for navigating. The navigation device 990 may be directly connected to the electronic device 905, and it may store the specific position bookmark built by the bookmark building module 970 for navigating.

The elements 910-970 of the system for the information corresponding to the geographical position 900 may also directly be used at a navigation device. The specific position bookmark built by the bookmark building module 970 may also be used for navigating directly.

In the embodiment, the system for the information corresponding to the geographical position 900 may further include a map database 995, and the latitude and longitude data or the position information of the specific position bookmark may be used to mark the specific position bookmark in the map. In addition, the map database 995 may also be included in the central server 980 or the navigation device 990 for the users to look over the specific position bookmark in the map.

To sum up, the invention has at least the following advantages.

First, in the invention, the position information is captured automatically from the electronic information. Therefore, the users do not need to input the data manually, and he or she may handle affairs conveniently

Second, in the invention, the information and the geographical position are combined, and a position bookmark is composed of the information and the geographical position. In other words, in the invention, the data captured from the electronic information may be converted to a position bookmark for the users to utilize the position bookmark further to navigate or plan travel and so on.

Third, in the invention, a central server may be used to collect the position bookmarks built by each user for the users to utilize the stored position bookmarks beforehand. Meanwhile, the users can use the position bookmarks built by other users to navigate or plan travel and so on.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for information corresponding to a geographical position, comprising the steps of:
capturing a plurality of words from electronic information;
searching out position information conforming to a specific address format in the words; and
converting the position information to latitude and longitude data.

2. The method for the information corresponding to the geographical position according to claim 1, wherein the step of capturing the words from the electronic information comprises the steps of:
browsing a web page via a browser, wherein the web page has the electronic information; and
capturing the words from the web page.

3. The method for the information corresponding to the geographical position according to claim 1, wherein the step of searching for the position information conforming to the specific address format comprises the steps of:
providing a plurality of address formats;
selecting out the specific address format from the address formats; and
searching for the words conforming to the specific address format and taking the words conforming to the specific address format as the position information.

4. The method for the information corresponding to the geographical position according to claim 1, wherein the step of searching for the position information conforming to the specific address format comprises the steps of:
providing an address database, wherein the address database stores corresponding relation of addresses and latitude and longitude; and
utilizing the corresponding relation to find out the latitude and longitude data that the position information corresponds to.

5. The method for the information corresponding to the geographical position according to claim 1, wherein the step of searching for the position information conforming to the specific address format further comprises the steps of:
searching out a plurality of reference position information in the words, wherein the reference position information conforms to the specific address format; and
displaying the reference position information.

6. The method for the information corresponding to the geographical position according to claim 5, wherein the step of searching for the position information conforming to the specific address format further comprises the step of:
selecting out the position information from the reference position information.

7. The method for the information corresponding to the geographical position according to claim 1, further comprising the steps of:
starting a map; and
marking the location of the position information in the map.

8. The method for the information corresponding to the geographical position according to claim 1, further comprising the step of:
building a specific position bookmark, wherein the specific position bookmark includes at least one of the position information and the latitude and longitude data.

9. The method for the information corresponding to the geographical position according to claim 8, further comprising the step of:
storing the specific position bookmark in a central server.

10. The method for the information corresponding to the geographical position according to claim 9, further comprising the steps of:
providing a navigation device, wherein the navigation device is connected to the central server; and
storing the specific position bookmark in the central server to the navigation device.

11. The method for the information corresponding to the geographical position according to claim 8, further comprising the step of:
storing the specific position bookmark in a navigation device.

12. The method for the information corresponding to the geographical position according to claim 8, further comprising the step of:
building the specific position bookmark in a map database via the latitude and longitude data or the position information of the specific position bookmark to mark the location of the specific position bookmark in a map.

13. The method for the information corresponding to the geographical position according to claim 1, wherein the position information comprises an address or a coordinate.

14. The method for the information corresponding to the geographical position according to claim 1, wherein the electronic information comprises an E-mail.

15. The method for the information corresponding to the geographical position according to claim 1, wherein the step of searching out the position information conforming to the specific address format in the words further comprises the step of:
searching out telephone information in the words.

16. A system for information corresponding to a geographical position, comprising:
a word capturing module for capturing a plurality of words from electronic information;
a searching module for searching for position information conforming to a specific address format in the words; and
a geographical information converting module for converting the position information to latitude and longitude data.

17. The system for the information corresponding to the geographical position according to claim 16, further comprising:
a browser for browsing a web page,
wherein the web page has the electronic information, and the word capturing module captures the words from the web page.

18. The system for the information corresponding to the geographical position according to claim 16, further comprising:
a format database for storing a plurality of address formats,
wherein the searching module utilizes the address formats to search out the position information conforming to the specific address format of the address formats.

19. The system for the information corresponding to the geographical position according to claim 16, further comprising:
an address database for storing corresponding relation of addresses and latitude and longitude,
wherein the geographical information converting module utilizes the corresponding relation in the address database to find out the latitude and longitude data which the position information corresponds to.

20. The system for the information corresponding to the geographical position according to claim 16, further comprising:
a bookmark building module for building a specific position bookmark, wherein the specific position bookmark includes at least one of the position information and the latitude and longitude data;
a central server, coupled with the bookmark building module, for storing the specific position bookmark; and
a navigation device, coupled with the central server, for downloading the specific position bookmark in the central server.
